(19) United States
(12) Patent Application Publication
(10) Pub. No.: US 2015/0147797 A1
(43) Pub. Date: May 28, 2015

(54) SYSTEMS AND METHODS FOR AUTOMATED BIOMASS SAMPLING AND ANALYSIS

(71) Applicant: POET Research, Inc., Sioux Falls, SD (US)

(72) Inventors: Alex C. Johnson, Valley Springs, SD (US); Adam R. Wirt, Lennox, SD (US)

(21) Appl. No.: 14/400,763

(22) PCT Filed: Mar. 7, 2013
(86) PCT No.: PCT/US2013/029598

§ 371 Date: Nov. 12, 2014

Related U.S. Application Data
(60) Provisional application No. 61/647,598, filed on May 16, 2012.

(51) Int. Cl. G01N 21/84; G01N 21/359; G01N 21/01

(52) U.S. Cl. CPC G01N 21/84; G01N 21/01; G01N 21/359; G01N 2021/0106
USPC 435/165; 435/161; 568/840; 250/339.01

(57) ABSTRACT

An apparatus for measuring moisture content of biomass is disclosed. Systems and methods for measuring the compositional content of biomass is disclosed, which assists in gauging quality of the biomass for any given purpose, and may assist in properly valuing the biomass during transactions. The system includes a coring probe apparatus located at a sampling area, a pneumatic transportation system which transports the core samples by collected by the coring probe to an analysis site, a sample homogenizer that homogenizes the core samples, and a near infrared analyzer calibrated for the biomass which generates a compositional profile for the homogeneous sample. The compositional profile generated by the near infrared analyzer includes values for ash, lignin and carbohydrates in the sample. Calibrating the near infrared analyzer for the biomass includes comparing near infrared scanning results against wet chemistry results.

### PRIORITY

The present non-provisional patent Application claims priority under 35 USC §119(e) from U.S. Provisional Patent Application having Ser. No. 61/647,598, filed May 16, 2012, entitled “SYSTEMS AND METHODS FOR AUTOMATED BIOMASS SAMPLING AND ANALYSIS,” the entirety of which is incorporated herein by reference.

### BACKGROUND

Ethanol can be produced from grain-based feedstocks (e.g. corn, sorghum/milo, barley, wheat, etc.), from sugar (e.g. from sugar cane, sugar beets, etc.), and from biomass (e.g. from lignocellulosic feedstocks such as switchgrass, corn cobs and stover, wood, other plant material, or algae).

Biomass comprises plant matter that can be suitable for direct use as a fuel/energy source or as a feedstock for processing into another bio-product (e.g., a biofuel such as cellulosic ethanol) produced at a biorefinery (such as an ethanol plant). Biomass may comprise, for example, corn cobs and stover (e.g., stalks and leaves) made available during or after harvesting of the corn kernels, fiber from the corn kernel, switchgrass, farm or agricultural residue, wood chips or other wood waste, algae, and other plant matter. In order to be used or processed, biomass is harvested and collected from the field and transported to the location where it is to be used or processed. An example of a way to efficiently collect and transport biomass is biomass bales. Biomass may be collected and baled during or after grain harvest.

In a conventional ethanol plant producing ethanol from corn, ethanol is produced from starch. In contrast, in a biorefinery configured to produce ethanol from biomass such as cellulosic feedstocks, ethanol is produced from lignocellulosic material (e.g. cellulose and/or hemi-cellulose). The biomass is prepared so that sugars in the cellulosic material (such as glucose from the cellulose and xylose from the hemi-cellulose) can be accessed and fermented into a fermentation product that comprises ethanol (among other things). The fermentation product is then sent to the distillation system where the ethanol is recovered by distillation and dehydration. Other bioproducts such as lignin and organic acids may also be recovered as co-products. Determination of how to more efficiently prepare and treat the biomass for production into ethanol will depend upon (among other things) the form and type or composition of the biomass.

For example, the moisture content, carbohydrate content, and ash content of biomass bales varies considerably based on harvest conditions, harvest timing, storage conditions, and the like. Knowledge of these compositional elements of the biomass material brought to the facility directly affects the amount of water introduced into the ethanol production process, yields of ethanol per weight of biomass processed, and overall system economics. As such, knowing the composition of the biomass at the time of purchase is beneficial, because the price of the bales is usually set on a dry matter basis, and may be adjusted by ash and carbohydrate levels to incentivize good collection and storage procedures by the farmers. It would also be beneficial for farmers to be able monitor the biomass content of their bales in storage.

In addition to use in a cellulosic ethanol production facility, biomass may likewise be utilized in a wide variety of downstream applications, such as feedstock for farm animals, fertilizer and compost materials, ground cover, and the like. In each of these applications, determining the moisture, carbohydrate and ash content of the biomass may be particularly important for assessing quality and/or pricing for the biomass product.

Currently in order to determine the content of moisture, carbohydrate and ash in a biomass sample, the material must be subjected to labor intensive, and potentially hazardous, wet chemistry assays. These protocols typically include drying the biomass (which takes considerable time) in order to determine moisture content. The resulting dry biomass may then be analyzed for carbohydrate and ash through spectroscopy and/or wet chemistry.

It is known that Near Infrared Spectroscopy (NIR) may be utilized to ascertain some of the content data of a sample; however NIR has proven insufficient for biomass sampling previously due to the heterogeneous nature of the biomass, difficulty in calibration, and logistics required in collecting the biomass samples.

It would be advantageous to provide for systems and methods for measuring the composition of biomass in a rapid and accurate manner using spectroscopy. Such systems and methods would provide consumers of biomass better characterization of their materials before utilizing it.

### SUMMARY

The present invention relates to systems and methods for measuring the compositional content of biomass. Such systems and methods may assist in gauging quality of the biomass for any given purpose, and may assist in properly valuing the biomass during transactions.

In some embodiments, the system for analyzing the compositions of biomass includes a coring probe apparatus located at a sampling area, a pneumatic transportation system which transports the core samples collected by the coring probe to an analysis site, a sample homogenizer that homogenizes the core samples, and a near infrared analyzer calibrated for the biomass which generates a compositional profile for the homogeneous sample.

In some embodiments, the coring probe is about three inches in diameter and at least sixteen inches in length. It may be an auger device, or a hollow coring saw. The coring probe may be mounted on a mechanical device for manipulating the coring probe, such as a boom arm.

The sample homogenizer reduces particle size of the core samples and mixes it prior to delivery to the near infrared analyzer. The compositional profile generated by the near infrared analyzer includes values for ash, lignin and carbohydrates in the sample. Calibrating the near infrared analyzer for the biomass includes comparing near infrared scanning results against wet chemistry results. From start to finish, such a system operates such that the time between removing the core samples and generating the compositional profile under about 3-5 minutes.

Note that the various features of the present invention described above may be practiced alone or in combination. These and other features of the present invention will be described in more detail below in the detailed description of the invention and in conjunction with the following figures.

In one aspect, the invention relates to a system for analyzing composition of biomass. The system includes: an apparatus capable of removing a sample from a collection of biomass; a transportation system capable of transporting the sample from the apparatus to an analysis site; a homogenizer capable of homogenizing the sample to produce a homogeneous sample; and a near infrared analyzer calibrated to analyze the composition of the biomass. The near infrared analyzer can be used to generate a compositional profile of the sample.

In another aspect the invention relates to a method for analyzing biomass. The method includes: removing at least one sample from a collection of biomass; transporting the at least one sample to an analysis site; homogenizing the at least one sample to generate a homogeneous sample; and analyzing the homogeneous sample with a near infrared analyzer to generate a compositional profile.

### DESCRIPTION OF THE DRAWINGS

In order that the present invention may be more clearly ascertained, some embodiments will now be described, by way of example, with reference to the accompanying drawings, in which:

FIG. 1 is a perspective view of a biorefinery comprising a cellulosic ethanol production facility.

FIG. 2 is a schematic diagram of a system for receipt and preparation of biomass for a cellulosic ethanol production facility.

FIG. 3 is a schematic block diagram of an apparatus used for preparation, pre-treatment, and separation of biomass.

FIG. 4 is a schematic block diagram of a system for the collection, treatment and near infrared analysis of biomass samples, according to an embodiment.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and structures have not been described in detail in order to not unnecessarily obscure the present invention. The features and advantages of embodiments may be better understood with reference to the drawings and discussions that follow.

The present invention relates to the collection, treatment and near infrared (NIR) analysis of biomass samples for characterization of bulk biomass prior to use of the biomass in a manufacturing process, such as before an initial step of pre-treatment of the biomass. In some embodiments, the bulk biomass that is sampled and tested may include substantially unprocessed biomass material in a form in which the bulk biomass is delivered to a facility of a user, such as to a cellulosic ethanol production facility. The delivered bulk biomass may be in a form of loose or baled agricultural residue, switch grass or other biomass crop, or other organic materials.

The biomass may be destined for processing into ethanol, or other biologically derived chemical, in a cellulosic biorefinery. Alternatively, the biomass may be used as animal bedding, livestock feed, groundcover, or fertilizer, among other known or future known applications. Much of the disclosure will center on the application of biomass for use as a raw material for cellulosic ethanol production. This detailed disclosure of biomass for use in ethanol production is intended to merely illustrate an example application for the use of biomass. These examples are not intended in any way to limit the scope of the embodiments to biomass for any particular purpose.

For any of the above purposes, knowledge of the composition of the biomass may assist in the proper processing conditions, accurate and cost effective means for payment for the material, and proper dosage/utilization rates. For example, in a biorefinery generating ethanol, biomass with higher carbohydrate levels may fetch a premium at the time of purchase, will generate higher ethanol yields, and require lower dosing rates to achieve the desired performance than lower carbohydrate materials. In contrast, for particular feed purposes, higher fiber content may be equally desirable. By characterizing the biomass, the best utilization of the material may be achieved.

As stated above, a number of means can be used to determine biomass composition and quality. Drawback of these systems and methods are that they tend to be expensive over the long term (after large number of samples are taken), require specialized personnel to perform, are potentially hazardous, and cannot be effectively implemented on bulk biomass shipments due to the scale and heterogeneous nature of the materials. As such, disclosed herein are mechanisms for overcoming these technical and logistic hurdles, to provide robust means for biomass characterization on a scale previously thought impractical.

The present methods use spectroscopy, including infrared, especially near infrared spectroscopy, to obtain a chemical analysis of biomass, or compositional profile, meaning a description of types and amounts of various chemical constituents of the biomass.

Examples of chemical constituents that may desirably be identified in a compositional profile, along with their amounts or relative amounts in a biomass sample, can include one or more of: water (moisture content), cellulose (glucan), lignin, hemicellulose, starch, ash, xylan, arabinan, acetate, and others as desired. The results of this analysis, i.e., the compositional profile, can be useful for making decisions relevant to the value of the tested biomass or how the tested biomass will be used or processed, such as: a value or price to be paid for the tested biomass; a use for the biomass (e.g., whether to process the biomass to form ethanol, to use the biomass to extract or process for a different chemical constituent, or to use the biomass as silage); or in identifying process conditions or additives and amounts thereof to be added to the biomass during a subsequent processing step.

The biomass is preferably tested and the compositional profile produced before the processing of the biomass begins. A sample of the biomass is taken from the biomass; this sample may be taken from the bulk biomass as the bulk biomass is delivered to a manufacturing or processing facility; the sample may be removed as a sample (e.g., a core sample) taken from a collection of the biomass as received at the facility, for example while the biomass is still located on a delivery vehicle such as a truck, trailer, rail car, barge, or other transport or delivery vehicle.

The sample may be processed by homogenizing the sample, e.g., by grinding the sample and mixing the ground sample to a homogenous sample that is representative of the bulk biomass. Multiple samples may be taken and homogenized and mixed, with results averaged if desired.

Note that the following disclosure includes a series of subsections. These subsections are not intended to limit the scope of the disclosure in any way, and are merely for the sake of clarity and ease of reading. As such, disclosure in one section may be equally applied to processes or descriptions of another section if and where applicable. Also note that while particular consideration is made to the use of corn kernels as the starting feedstock, other materials may be substituted in particular embodiments. For example, soybean, or a combination of grains, may be utilized in some cases to generate ethanol and co-products under low energy conditions. This may result in other novel compositions that are considered within the scope of the present disclosure.

Note that much of the biomass discussed in this application includes corn cob and stover (e.g. leaves, and stalks) biomass. While corn biomass is plentiful, and of particular interest in use for some applications of cellulosic ethanol production, the present disclosure is intended to be equally applicable to all sources of biomass, including for example wood by-products, switch grass, hemp, peat, virtually any plant material, and algae including seaweeds. The discussions of biomass including corn plant derived materials are, thus, intended to be entirely for clarification and exemplary purposes.

### I. BIOMASS

According to certain embodiments of the invention, useful biomass is the type of biomass useful to produce ethanol. This may include any type of biomass from which ethanol can be derived, including non-lignocellulosic biomass sources such as grains (sorghum, corn, barley, wheat, etc.); sugar such as sugar cane, sugar beets, etc.; and lignocellulosic biomass such as switchgrass, corn cobs and stover, etc.

Lignocellulosic biomass as delivered to a facility and that is untreated (e.g., has not yet been subject to pre-treatment) may contain cellulose, hemicellulose, and lignin in amounts that will be typical of such biomass in a raw and unprocessed form. Certain useful types of biomass are materials from the corn plant, such as corn cobs, husks and leaves and stalks (e.g., at least upper half or three-quarters portion of the stalk). According to some embodiments, the plant material comprises corn cobs, husks, leaves and stalks; for example, the plant material may include up to 100% by weight corn cobs; up to 100% by weight husks, leaves, or a combination of these; about 50% cobs and about 50% husks and leaves; about 30% cobs and about 50% husks and leaves, and about 20% stalks. Any of a wide variety of other combinations of cobs, husks, leaves, and stalks from the corn plant may also be useful. According to exemplary bulk un-treated corn-based biomass, the biomass may contain at least about 20% to about 30% corn cobs (by weight) with corn stover and other matter.

According to other embodiments, the lignocellulosic plant material may comprise fiber from the corn kernel (e.g., in some combination with other plant material).

In some embodiments, the composition of the plant material (i.e., cellulose, hemicellulose, and lignin) will be approximately as shown in TABLES 1A and 1B (i.e., after at least initial preparation of the biomass, including removal of any foreign matter).

TABLE 1B provides ranges believed to be representative of the composition of biomass comprising lignocellulosic material from the corn plant. According to some embodiments, the lignocellulosic plant material of the biomass (from the corn plant) will comprise cellulose at about 30% to about 55% by weight, hemicellulose at about 20% to about 50% by weight, and lignin at about 10% to about 25% by weight. According to an exemplary embodiment, the lignocellulosic plant material of the biomass (i.e., cobs, husks/leaves and stalk portions from the corn plant) will comprise cellulose at about 35% to about 45% by weight, hemicellulose at about 24% to about 42% by weight, and lignin at about 12% to about 20% by weight.

TABLE 1A
Biomass Composition

| | Husks/ | | Cellulose | Hemicellulose | | | | | |
|---|---|---|---|---|---|---|---|---|---|
| Cob | Leaves | Stalk | (Glucan) | Xylan | Arabinan | Acetate | Composite | Lignin | Ash |
| (percent) | (percent) | (percent) | (percent) | (percent) | (percent) | (percent) | (percent) | (percent) | (percent) |
| 100 | 0 | 0 | 36.0 | 33.3 | 3.6 | 3.0 | 39.9 | 14.9 | 2.2 |
| 0 | 100 | 0 | 37.2 | 25.6 | 4.9 | 2.2 | 32.7 | 13.0 | 7.7 |
| 0 | 0 | 100 | 41.7 | 22.5 | 2.4 | 2.6 | 27.5 | 18.3 | 3.7 |
| 50 | 0 | 50 | 38.8 | 27.9 | 3.0 | 2.8 | 33.7 | 16.6 | 3.0 |
| 50 | 50 | 0 | 36.6 | 29.5 | 4.2 | 2.6 | 36.3 | 14.0 | 5.0 |
| 30 | 50 | 20 | 37.7 | 27.3 | 4.0 | 2.5 | 33.8 | 14.6 | 5.3 |

TABLE 1B
Biomass
Typical and Expected Composition

| | Cellulose | | | |
|---|---|---|---|---|
| | (Glucan) | Hemicellulose | Lignin | Ash |
| | (percent) | (percent) | (percent) | (percent) |
| | (approx.) | (approx.) | (approx.) | (approx.) |
| Typical Range | 35-45 | 24-42 | 12-20 | 2-8 |
| Expected Range | 30-55 | 20-50 | 10-25 | 1-10 |

The amount of water contained in untreated bulk biomass—meaning the moisture content, which is water present as part of the plant material but not water added to the plant material or applied to the plant material, such as for washing or removing contaminants or foreign matter—can be an amount naturally present in the harvested plant material, optionally after an amount of natural or artificial (accelerated) drying. Moisture content of bulk biomass (not including any water optionally added or applied to the biomass) is generally below about 50 percent, e.g., less than about 40 percent, such as from about 10 or 15 percent to about 30 or 40 percent. According to embodiments of methods as described, a sample removed from the biomass, transported, homogenized, and analyzed with a near infrared analyzer can have a moisture content within one or more of these ranges.

Upon receipt of biomass material in a transport vehicle, the bulk biomass can be unloaded, optionally un-baled or unwrapped, cleaned to remove foreign matter, and optionally ground (e.g., milled, reduced, or processed to reduce density); and the biomass can be transported and conveyed from a delivery or receiving location, for processing at the plant. These steps are considered to be preparation steps, and are not considered to be “pre-treatment” steps.

Before or after preparation steps, and preferably before any pre-treatment steps, a sample of the bulk biomass material is taken and prepared for compositional testing, and tested (as described elsewhere herein). In preferred methods the biomass can be sampled for testing before substantial processing of the biomass, e.g., before pretreatment.

The term “pre-treatment” (pre-treating, pre-treated) refers to methods of processing a biomass material (e.g., cellulosic biomass such as corn stover, switchgrass, and the like), after delivery to a processing facility, after removal of the biomass from a delivery vehicle, and after other preparation steps; during pre-treatment, biomass is subject to processing that is effective to initiate chemical breakdown of the structural or cellulosic materials of the biomass. Pretreatment of lignocellulosic biomass may be useful to break down the structure of the biomass to allow desired contents (e.g., cellulosic contents) of the biomass to be made more accessible for later processing. Pretreatment can also initiate or include separating components of the biomass into a liquid component (e.g. a stream comprising the C5 sugars) and a solids component (e.g. a stream comprising cellulose from which the C6 sugars can be made available). (Subsequently, the C5-sugar-containing liquid component (C5 stream) and C6-sugar-containing solids component (C6 stream) can be further treated, fermented, distilled, etc., to produce and recover. Examples of useful equipment, steps, and conditions for pre-treatment processes are explained and illustrated, e.g., at Applicant's copending patent application, PCT/US2011/029047 (WO 2011/11617), and United States patent application 2011/0079219 (Ser. No. 12/888,957), the entireties of these being incorporated herein by reference.

Various different conditions, added materials (e.g., chemicals, recycle streams, bioactive materials, catalysts), and processing steps, are useful and may be used in different combinations during pre-treatment of biomass. As indicated, a sample of biomass used for testing according to specific methods of the present description can preferably be removed from bulk biomass before the biomass is subjected to any of these pretreatment conditions, added materials, or steps. Some pretreatment steps involve exposing biomass to elevated temperature, such as a temperature in a range from 110 to 250° C., e.g., for a time in a range from 1-60 minutes. Other examples may involve hot water extraction; dilute acid hydrolysis, at high (e.g., 110 to 250° C.), or low (e.g., below 110° C.); alkaline oxidation; steam explosion.

### II. ETHANOL PRODUCTION FROM BIOMASS

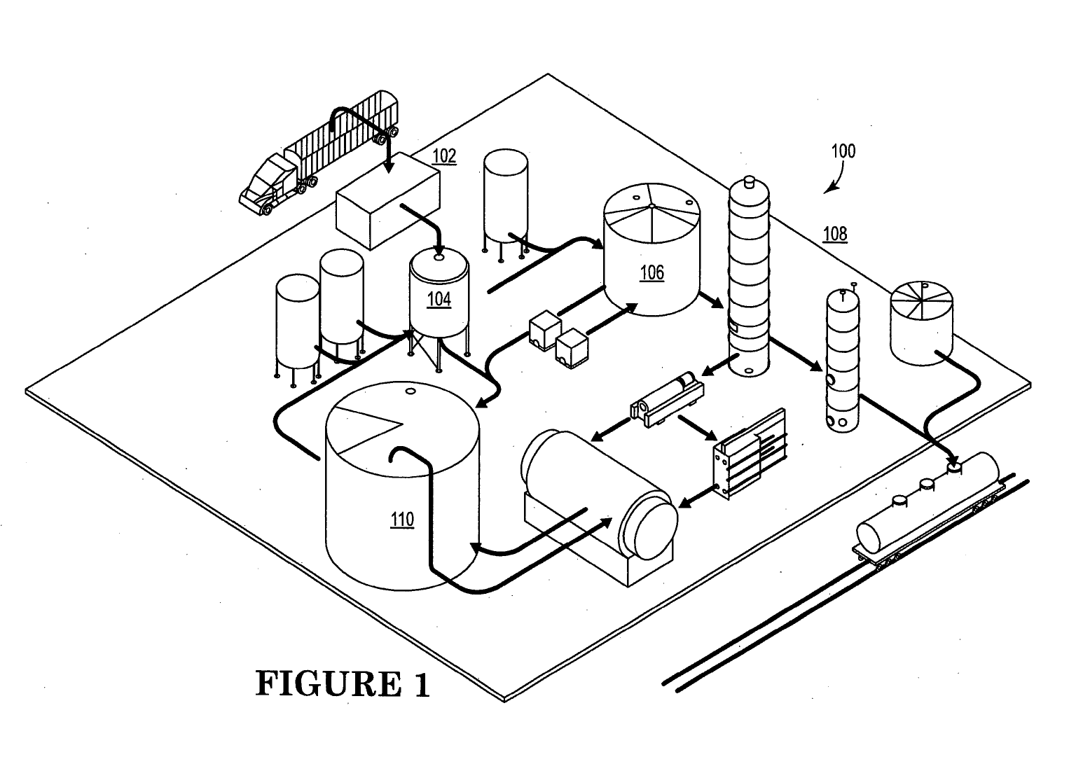

In order to facilitate disclosure, FIG. 1 illustrates a biorefinery 100 configured to produce ethanol, or other biologically derived chemical, from biomass. According to an exemplary embodiment, the biorefinery 100 is configured to produce ethanol from biomass in the form of a lignocellulosic feedstock such as plant material from the corn plant (e.g., corn cobs and corn stover). Lignocellulosic feedstock such as lignocellulosic material from the corn plant comprises cellulose (from which C6 sugars such as glucose can be made available) and/or hemicellulose (from which C5 sugars such as xylose and arabinose can be made available).

As shown in FIG. 1, the biorefinery 100 comprises an area where biomass is delivered and prepared to be supplied to the cellulosic ethanol production facility. The cellulosic ethanol production facility comprises an apparatus for preparation 102, pre-treatment 104 and treatment of the biomass into treated biomass suitable for fermentation into fermentation product in a fermentation system 106. The facility comprises a distillation system 108 in which the fermentation product is distilled and dehydrated into ethanol.

As shown in FIG. 1, the biorefinery may also comprise a waste treatment system 110 (shown as comprising an anaerobic digester and a generator). According to other alternative embodiments, the waste treatment system may comprise other equipment configured to treat, process, and recover components from the cellulosic ethanol production process, such as a solid/waste fuel boiler, anaerobic digester, aerobic digester or other biochemical or chemical reactors.

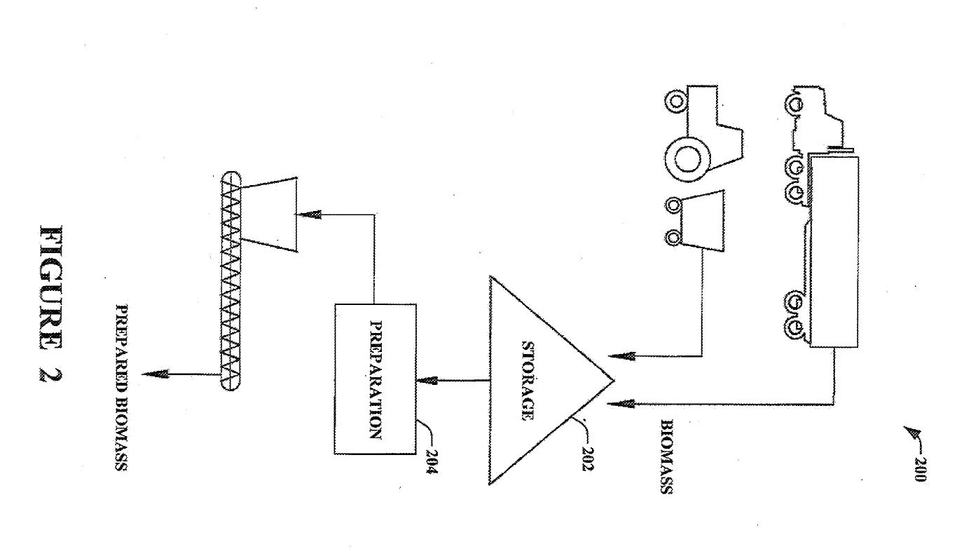

Referring to FIG. 2, a system 200 for preparation of biomass delivered to the biorefinery is shown. The biomass preparation system 200 may comprise an apparatus for receipt/unloading of the biomass, cleaning (e.g., removal of foreign matter), grinding (e.g., milling, reduction, or densification), transport, and conveyance for processing at the plant. According to an exemplary embodiment, biomass in the form of corn cobs and stover may be delivered to the biorefinery and stored (e.g., in bales, piles or bins, etc.), shown as storage 202, and managed for use at the facility. According to an embodiment, the biomass may comprise at least 20 to 30 percent corn cobs (by weight) with corn stover and other matter. According to other exemplary embodiments, the preparation system 204 of the biorefinery may be configured to prepare any of a wide variety of types of biomass (e.g., plant material) for treatment and processing into ethanol and other byproducts at the plant.

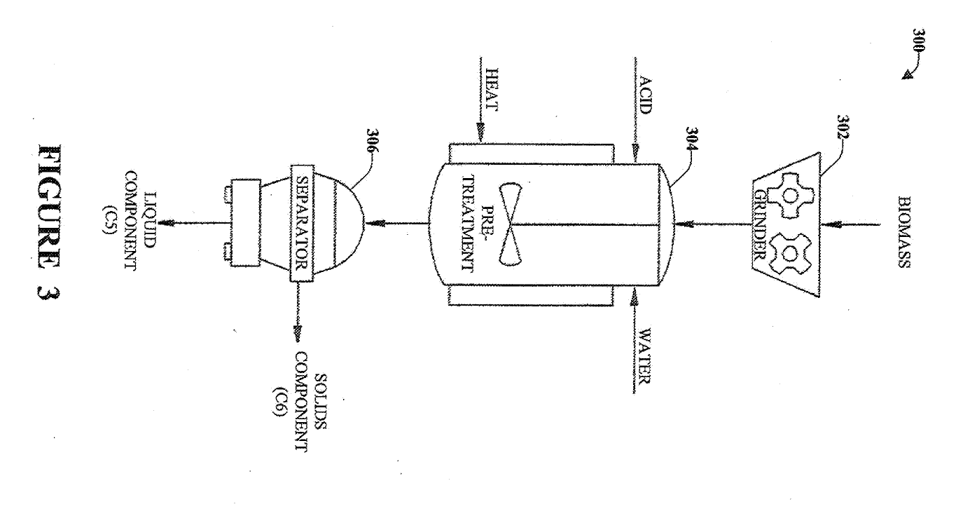

FIG. 3 illustrates the apparatus 300 used for preparation, pre-treatment, and separation of lignocellulosic biomass according to an exemplary embodiment. As shown, biomass is prepared in a grinder 302 (e.g., grinder or other suitable apparatus or mill). Pre-treatment 304 of the prepared biomass is performed in a reaction vessel (or set of reaction vessels) supplied with prepared biomass and acid/water in a predetermined concentration (or pH) and other operating conditions. In this example downstream use for biomass, the composition of the starting biomass material may be particularly important in that it may vary the amount of water, acid, biomass solids, enzymes, and/or process conditions needed to properly pre-treat the biomaterial. The pre-treated biomass can be separated in a centrifuge 306 into a liquid component (C5 stream comprising primarily liquids with some solids) and a solids component (C6 stream comprising liquids and solids such as lignin and cellulose from which glucose can be made available by further treatment).

According to an embodiment, in the pre-treatment system an acid, such as sulfuric acid, hydrochloric acid, nitric acid, phosphoric acid, acetic acid, etc. (or a formulation/mixture of acids), can be applied to the prepared biomass to facilitate the breakdown of the biomass for separation into the liquid component (C5 stream from which fermentable C5 sugars can be recovered) and the solids component (C6 stream from which fermentable C6 sugars can be accessed).

The liquid component (C5 stream) comprises water, dissolved sugars (such as xylose, arabinose and glucose) to be made available for fermentation into ethanol, acids and other soluble components recovered from the hemicellulose. The solids component (C6 stream) comprises water, acids and solids such as cellulose from which sugar, such as glucose, can be made available for fermentation into ethanol, and lignin. According to an embodiment, the biomass material may comprise about 15 to 50 percent (dry weight) cobs, 35 to 65 percent (dry weight) leaves and husks, 10 to 30 percent (dry weight) stalk, and, in accordance with some embodiments, less than 5 percent (dry weight) foreign material. For alternative biomass sources, such as wood chips, the composition of the biomass may vary greatly.

The composition of biomass varies, for example, based on starting material compositions, harvest conditions/practices, harvest timing, and storage conditions. For example, the moisture content of example corn bales may vary from less than 20 percent to more than 40 percent. Likewise, carbohydrate and ash compositions may vary significantly as well.

It would be beneficial to be able to control the moisture content of the biomass brought to the facility and the amount of water introduced into the ethanol production process, in these embodiments. Likewise, being able to tailor process conditions, loading levels, and yield expectations according to biomass composition is highly beneficial. It would also be beneficial to know the composition of the biomass, when biomass is purchased, because the price of the biomass is usually set on a dry matter basis, and may be pegged to its efficacy in downstream processes. It would also be beneficial for farmers to be able monitor the composition of their biomass in storage. Note that biomass may often be collected into bales for transportation or storage purposes. It is intended that some embodiments of the collection and NIR analysis system are equally usable with biomass in baled form as well as loose biomass material.

### III. SYSTEM FOR COLLECTING AND NIR ANALYSIS OF BIOMASS SAMPLES

Many assays exist for determining moisture content of plant materials, often comprising measuring weight loss during drying in an oven, for example. Measuring moisture content using an oven usually consumes considerable time and is not a portable method. Wet chemistry can be employed for determining other compositional date, such as carbohydrate levels and ash levels. These systems all require long assays, specialized operators, and potential hazardous reagents or equipment. One solution to these drawbacks in known sample characterizations includes relying upon Near Infrared (NIR) analysis; however, given the scale and heterogeneous nature of biomass for use in a bulk manufacturing process, current systems have not been successful.

In response to this need, systems and methods of collection and NIR analysis are provided which overcome the shortfalls of previous systems. In the disclosed systems and methods, novel sampling mechanisms are employed which enable more representative sampling of bulk biomass material, despite its inherent heterogeneous nature. This allows for effective use of NIR technology to produce robust and accurate compositional data regarding biomass.

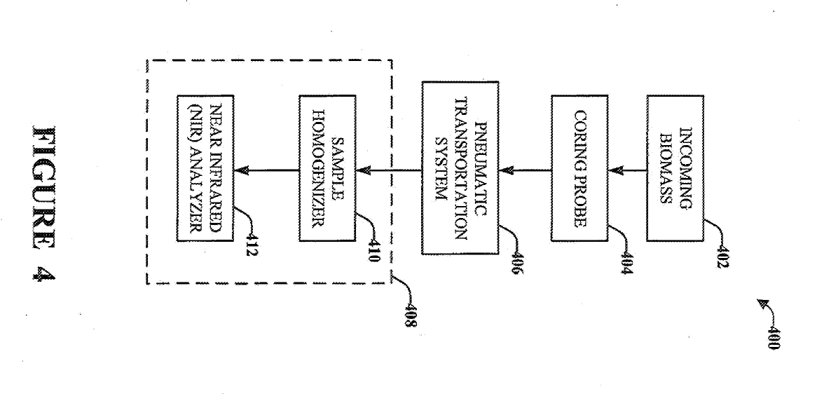

FIG. 4 is a schematic block diagram of a system for the collection, treatment and near infrared analysis of biomass samples, shown generally at 400. In this example schematic, incoming biomass 402 is delivered to a sample staging area where a coring probe 404 removes one or more core samples from the bulk biomass. Typically biomass is delivered as loose materials or bales by truck. It is advantageous to sample the biomass without having to remove the materials from the transportation vehicle. As such, the coring probe 404 may be mounted on a movable boom arm, or similar device, to take the core samples directly from the biomass located on the truck, rail car, barge, or other transport.

When biomass has been baled, the material is extremely dense and compact. This renders the collection of a core sample a non-trivial endeavor which requires an cutting tool to extract a sample of the material, e.g., an auger, hollow coring saw device, or similar such useful cutting tool. This device may drill or cut the core sample from the bale using mechanical manipulation. The core sample extends from the surface of the bale (or loose biomass pile) to some interior portion, thereby ensuring a more representative cross section of biomass material. Due to storage conditions and handling, the compositional profile of the external portion of the bale may vary from internal regions. Thus, a core sample is required to properly sample the full range of the bale composition. In some embodiments, the coring probe 404 may include a coring saw of around three inches in diameter and a length of at least 16 inches. Alternately, the coring saw or augur may have a diameter in a range from about 2 to about 6 inches and a length of at least 13 inches, e.g., a diameter in a range from about 2 to about 5 inches and a length of at least 15 inches.

Additionally, in some embodiments, it may be beneficial to take a multitude of core samples from one or more bales in order to ensure a more representative sample. Typically between 3-5 core samples may provide a reasonably representative sample of the bulk biomass. Greater numbers of core samples may be more accurate, but due to diminishing return on sample accuracy, it may be beneficial to not spend time and resources on greater numbers of samples. Biomass, by its very nature, tends to be relatively heterogeneous material; as such having a plurality of samples may be beneficial. Further, if the biomass being collected tends to be more heterogeneous (such as corn agricultural residue), then it may be desirable to have greater numbers of core samples. In contrast, more homogeneous materials (such as switch grass bales) may require fewer core samples to yield representative material.

As the cores are generated, these samples may pass through a pneumatic transportation assembly 406 to transport the biomass core samples from the collection site to an analysis site 408, such as a scale house, on-site lab or the like.

At the analysis site 408, the core samples may be homogenized through mechanical means at a sample homogenizer device 410. This sample homogenizer 410 may include a grinder assembly, ultrasonic disrupter, mill or other mechanism to reduce particle size and mix a sample to ensure homogeneity. The size and degree of mixing are sufficient such that different aliquots of a single homogenized sample produce essentially identical results upon compositional testing with NIR spectroscopy.

The homogenized sample may then be provided to a Near Infrared (NIR) analyzer 412 for rapid and accurate analysis of the biomass composition. The NIR analyzer 412 may be calibrated according to control samples whose compositions have been determined through wet chemistry procedures. The NIR system may use a calibration specific to the type of biomass being brought in. This calibration may identify carbohydrates, lignin, ash, and moisture levels, and any other desired constituents and levels thereof.

Note that a number of NIR calibrations exist for dry samples. The incoming homogenized biomass is still a “wet” sample, in that the moisture has not been removed prior to scanning. By comparing the NIR results to the compositional results generated through wet chemistry procedures, a novel and unique calibration is generated for the incoming wet biomass sample.

Once calibrated, the NIR analyzer 412 generates a compositional profile for the homogenized sample rapidly, enabling on-the-spot cataloguing of the incoming biomass lots, purchase price adjustments for the biomass dependent upon the composition, or even designating the use of the biomass according to its most suitable end use. The entire process may take less than three minutes from coring to. NIR analysis, advantageously not slowing down traffic of biomass delivery vehicles (e.g., trucks) during delivery of biomass to a biomass processing facility.

### III. EXAMPLES

A limited example was conducted according to an exemplary embodiment of the system in an effort to determine suitable apparatus and operating conditions for an apparatus for biomass composition.

### Example 1

The system as shown in FIG. 4 was used in an experiment to test the effectiveness and accuracy of a NIR based system for measuring corn second-pass bale material compositions in comparison to wet chemistry analysis. Standard wet chemistry procedures were employed to determine glucan, xylan, arabinan, acetate, lignin and ash levels in the biomass samples. The NIR analyzer was utilized to generate values for each of these same components for each sample. The results between the wet chemistry and the NIR results may be compared to generate the calibration for this biomass class. Table 2 provides the results of this comparison between wet chemistry and NIR analysis over nine representative corn agricultural residue bale samples.

TABLE 2
Comparison between NIR results and wet chemistry analysis

| Calibration Comparison | Sample | Glucan | Xylan | Arabinan | Acetate | Lignin | Ash |
|---|---|---|---|---|---|---|---|
| NIR Prediction | 1 | 29.153 | 20.467 | 2.814 | 1.882 | 11.837 | 7.896 |
| Wet Chemistry | 1 | 31.332 | 22.720 | 3.225 | 2.189 | 13.450 | 9.160 |
| Analysis | | | | | | | |
| NIR Prediction | 2 | 33.527 | 25.348 | 3.316 | 2.242 | 12.515 | 8.306 |
| Wet Chemistry | 2 | 32.836 | 24.480 | 3.724 | 2.152 | 14.654 | 6.105 |
| Analysis | | | | | | | |
| NIR Prediction | 3 | 32.264 | 24.524 | 3.359 | 2.184 | 13.199 | 7.974 |
| Wet Chemistry | 3 | 31.325 | 23.279 | 3.407 | 2.015 | 14.710 | 7.794 |
| Analysis | | | | | | | |
| NIR Prediction | 4 | 27.892 | 19.855 | 2.638 | 1.731 | 10.760 | 7.395 |
| Wet Chemistry | 4 | 25.885 | 17.020 | 2.309 | 1.494 | 12.212 | 15.029 |
| Analysis | | | | | | | |
| NIR Prediction | 5 | 32.839 | 24.087 | 3.175 | 2.156 | 11.807 | 7.659 |
| Wet Chemistry | 5 | 30.158 | 21.912 | 2.783 | 1.899 | 14.927 | 10.754 |
| Analysis | | | | | | | |
| NIR Prediction | 6 | 29.157 | 20.443 | 2.632 | 1.702 | 9.715 | 7.341 |
| Wet Chemistry | 6 | 27.503 | 19.119 | 2.523 | 1.680 | 13.452 | 14.399 |
| Analysis | | | | | | | |
| NIR Prediction | 7 | 28.993 | 20.782 | 2.422 | 1.790 | 9.885 | 6.828 |
| Wet Chemistry | 7 | 32.016 | 24.340 | 3.321 | 2.013 | 15.877 | 6.906 |
| Analysis | | | | | | | |
| NIR Prediction | 8 | 30.740 | 22.490 | 2.914 | 1.994 | 11.318 | 7.390 |
| Wet Chemistry | 8 | 29.725 | 19.877 | 2.515 | 1.756 | 14.106 | 13.166 |
| Analysis | | | | | | | |
| NIR Prediction | 9 | 30.792 | 22.049 | 3.067 | 2.014 | 12.118 | 7.705 |
| Wet Chemistry | 9 | 27.890 | 21.208 | 3.013 | 1.688 | 13.212 | 11.089 |
| Analysis | | | | | | | |

As can be seen, the NIR results are very consistent in generating predictions of biomass composition which may be easily, and accurately, mapped to actual results according to wet chemistry. As such, a reliable calibration measure may be defined and used to ensure the NIR results are meaningful.

The embodiments as disclosed and described in the application (including the Figures and Examples) are intended to be illustrative and explanatory of the present invention. Modifications and variations of the disclosed embodiments, for example, of the apparatus and processes employed (or to be employed) as well as of the compositions and treatments used (or to be used), are possible; all such modifications and variations are intended to be within the scope of the present invention.

The word “exemplary” is used to mean serving as an example, instance, or illustration. Any embodiment or design described as “exemplary” is not necessarily to be construed as preferred or advantageous over other embodiments or designs, nor is it meant to preclude equivalent exemplary structures and techniques known to those of ordinary skill in the art. Rather, use of the word exemplary is intended to present concepts in a concrete fashion, and the disclosed subject matter is not limited by such examples.

The term “or” is intended to mean an inclusive “or” rather than an exclusive “or.” To the extent that the terms “comprises,” “has,” “contains,” and other similar words are used in either the detailed description or the claims, for the avoidance of doubt, such terms are intended to be inclusive in a manner similar to the term “comprising” as an open transition word without precluding any additional or other elements.

1. A system for analyzing composition of biomass, the system comprising:
an apparatus capable of removing a sample from a collection of biomass;
a transportation system capable of transporting the sample from the apparatus to an analysis site;
a homogenizer capable of homogenizing the sample to produce a homogeneous sample; and
a near infrared analyzer calibrated to analyze the composition of the biomass, wherein the near infrared analyzer is capable of generating a compositional profile of the homogeneous sample.

2. The system of claim 1, wherein the apparatus is mounted on a mechanical mobility device.

3. The system of claim 1, wherein the apparatus is a coring probe selected from the group consisting of an auger and a coring saw.

4. The system of claim 1, wherein the sample homogenizer and the near infrared analyzer are located in the analysis site.

5. The system of claim 1, wherein the sample homogenizer reduces particle size of the sample and mixes the reduced size particles.

6. The system of claim 1, wherein the compositional profile includes amounts of ash, lignin, and carbohydrates.

7. The system of claim 1, wherein calibrating the near infrared analyzer for the biomass includes a comparison to an analysis of the biomass performed by wet chemistry techniques.

8. The system of claim 1, wherein the system operates such that the time between removing the sample and generating the compositional profile for the homogeneous sample is under about 5 minutes.

9. (canceled)

10. The system of claim 1, wherein the biomass is un-treated cellulosic biomass having a moisture content of less than about 50 percent.

11. The system of claim 10, wherein the un-treated cellulosic biomass comprises corn stover and corn cobs and the un-treated cellulosic biomass has a moisture content of less than about 40 percent.

12. (canceled)

13. A method for analyzing biomass, the method comprising:
removing at least one sample from a collection of biomass;
transporting the at least one sample to an analysis site;
homogenizing the at least one sample to generate a homogeneous sample; and
analyzing the homogeneous sample with the near infrared analyzer to generate a compositional profile.

14. The method of claim 13 comprising calibrating the near infrared analyzer for the biomass by comparing a compositional analysis of a biomass calibration sample performed using the near infrared analyzer to a compositional analysis of the biomass calibration sample performed using a different analyzer.

15. (canceled)

16. The method of claim 13, wherein the homogenizing and analyzing are performed at the analysis site.

17. The method of claim 13, wherein the homogenizing reduces particle size of the at sample and mixes the reduced size particles.

18. (canceled)

19. The method of claim 13, wherein the time between removing the at least one core sample and analyzing the homogeneous sample is under about 5 minutes.

20. (canceled)

21. The method of claim 13, wherein before removing the at least one sample, the method does not include exposing the biomass sample to one or more of: acid, elevated temperature, base, bio active organism, or bioactive compound.

22-24. (canceled)

25. The method of claim 13 comprising, after analyzing the homogeneous sample,
processing the biomass by applying water, base, acid, bioactive organism, or bioactive compound to the biomass or a process stream produced by processing the biomass, and
selecting the amount of water, base, acid, bioactive organism, or bioactive compound used in the process based on the compositional profile.

26. (canceled)

27. The method of claim 13 comprising, after analyzing the homogeneous sample, calculating a price to be paid for the biomass based on the compositional profile.

28. The method of claim 13 wherein the biomass is contained in a delivery vehicle, and the sample is removed from the biomass while the biomass is contained in the delivery vehicle.

29. The method of claim 13 wherein the sample is a cylindrical core sample having a diameter in a range from about 2 to about 6 inches and a length of at least 13 inches.

30. (canceled)
